(19) United States
(12) Patent Application Publication
(10) Pub. No.: US 2011/0006640 A1
(43) Pub. Date: Jan. 13, 2011

(54) PIEZOELECTRIC DRIVE DEVICE

(76) Inventors: Walter Haussecker, Buehlertal (DE); Vincent Rieger, Karlsruhe (DE); Volker Rischmueller, Leonberg (DE); Peter Froehlich, Changsha (CN)

Correspondence Address: MERCHANT & GOULD PC, P.O. BOX 2903, MINNEAPOLIS, MN, 55402-0903, US

(21) Appl. No.: 12/740,795

(22) PCT Filed: Sep. 12, 2008
(86) PCT No.: PCT/EP08/62125

§ 371 Date: Sep. 8, 2010

(30) Foreign Application Priority Data
Nov. 2, 2007 (DE) 102007052494.5

(51) Int. Cl. H02N 2/04

(52) U.S. Cl. 310/323.16

(57) ABSTRACT

The invention relates to a piezoelectric drive device for adjusting movable parts (11), particularly in a motor vehicle, having a piezo motor (12) having at least one piezo actuator comprising an electric piezo element, wherein at least one friction element (30) is disposed on the piezo motor (12), said element interacting with a friction surface (14) of at least one guide rail (16) opposite said friction element (30) for creating a relative movement, wherein the friction surface is positioned opposite of the friction element (30), wherein the at least one piezo motor (12) is supported on a first side (94) of a bearing bracket (8) and a counter element (98) is disposed on a second opposite side (95) of the bearing bracket (8), which exerts a counter force (97) to the friction element (30) onto the at least one guide rail (16).

### STATE OF THE ART

The invention relates to a piezoelectric drive device for adjusting movable parts according to the type of the independent claim.

A piezoelectric motor unit is known from EP 01712170 B1, with which a window can be opened and closed. A vertical extension is thereby for example attached at a window pane, whereby a piezoelectric motor unit is arranged on its opposite sides. The two piezoelectric drive devices are each separately located fixedly, whereby a vibration of the piezoelectric motor unit is enabled by a springy bearing. The disadvantage of such fixtures of the piezo motors is the relatively high tolerance chain, whereby the friction contact between the friction elements and the vertical extension can be influenced unexpectedly. This effect is increased by vibrations of the window pane, which can be locally construed in a varyingly strong way.

### DISCLOSURE OF THE INVENTION

Advantages of the Invention

According to the invention the piezoelectric drive device with the characteristics of the independent claim provides on the other hand the advantage that a defined pressure force of the friction element against the friction surface of the guide rail is always maintained due to the bearing of the at least one piezo motor in a bearing bracket. This is thereby realized, in that the bearing bracket is construed in such a way that a constant counter force is exerted preferably on the opposite of the friction element by a bearing bracket, whereby the friction contact between the friction element and the friction surface is independent of the inhomogeneous vibrations of the side vehicle door.

Due to the measures that are stated in the dependent claims advantageous improvements and configurations of the embodiments that are stated in the dependent claim are enabled. Thus for example the counter force for the first friction element is brought up by arranging an opposite piezo motor, which also pressed against a guide rail with a friction element from the opposite side. The second piezo motor that is construed as counter element is therefore connected with the first piezo motor over the rigid bearing bracket.

In a further embodiment the counter element is construed as a pressure element, which preferably exerts an almost dot-shaped counter force to the friction element of the first piezo motor onto one of the two guide rails. The bearing bracket encompasses therefore the one or two guide rails, whereby the pressure element is preferably formed as rigid end of the bearing bracket on the side that is opposing the first piezo motor.

For adjusting the movable part the at least one piezo motor carries out a relative movement with regard to the guide rail, whereby the guide rail can be construed corresponding to the adjusting path as a straight line or as several straight sections or arch-shaped. When using one or several guide rails they run almost parallel to each other.

The contact area of the first piezo motor is preferably arranged exactly on the opposite of the counter contact area of the counter element of the bearing bracket, whereby the contact-/counter contact areas are for example construed almost dot-shaped. In an alternative embodiment the contact point and the counter contact point can also be arranged offset to each other, in order to influence thereby the force transmission of the friction element onto the friction surface.

If the counter element touches at the same guide rail as the friction element of the first piezo motor the bearing bracket can be construed relatively short, which results in a relatively rigid tension of the friction element with the counter element, whereby the force transmission between the friction element and the friction surface is less interference-prone.

If the bearing bracket encompasses two guide rails the longer construed bearing bracket is less susceptible to vibration, but this way a bigger distance between the contact point of the first friction element and the contact point of the counter element from the vibrations of the car body can be decoupled as well.

The first piezo motor and if necessary also the further piezo motors are advantageously arranged flexibly in corresponding slots of the bearing bracket, in such a way that the springs exert a default pressure force of the friction elements onto the corresponding friction surfaces.

It is particularly advantageous, if the at least one piezo motor is connected fixedly over the bearing bracket, for example at the side door of the motor vehicle, and if the at least one guide rail, which is arranged at the movable part, shifts then on the opposite side of the at least one piezo motor. In that embodiment the electric supply of the piezo motors can be carried out fixedly and stationary.

The at least one guide rail is stationary in an alternative embodiment, preferably attached at the side door and the bearing bracket with the at least one piezo motor is fixed rigidly at the movable part—preferably the window pane. Due to the rigid arrangement of the at least one guide rail installation space in the adjusting direction can be saved, because the movable part with the bearing bracket can than overlap with the guide rail.

It is particularly advantageous, if the bearing bracket is attached almost dot-shaped at a single fixing point, for example at the car body or at the movable part, in order to decouple the force transmission of the friction elements as much as possible from outside influences. Alternatively also two fixing points can be provided, with which the bearing bracket can be fixed more reliable at the window pane. It is thereby advantageous to arrange the fixing points symmetrically to the bearing bracket.

According to the invention the bearing brackets of the piezoelectric drive device is suitable for storing either exactly one or two or three or four piezo motors in a single bearing bracket or three depending on the requirements for the adjusting force and the present installation space. Thereby a very low tolerance chain regarding the single friction elements and the corresponding frictions surfaces can be achieved. Without significant constructive changes single piezo motors can thereby be exchanged by pressure elements, in order to come up with the corresponding counter force.

For storing the at least one piezo motor in slots of the bearing brackets the piezo motor is preferably stored in the vibration node of the piezo actuator. This has the advantage that by storing at the positions of the piezo actuator, at which the vibration amplitude equals zero, the damping of the mechanic actuator vibration is minimized, whereby its efficiency is significantly increased. The mechanical fixing of the piezo motors in the bearing bracket is thereby adjusted to the electric excitation of the piezo elements, which is preferably possible due to a single-phased excitation of the piezo actuators.

If the piezo actuator is solely oscillated in longitudinal direction this results in a node level that is basically oriented vertically to the longitudinal direction and cuts the actuator housing in a peripheral line. At this vibration node the piezo actuator can be advantageously attached fixedly over its entire perimeter along the peripheral line, whereby a very rigid storing is achieved. It is advantageous to form a recess or an extension directly at the actuator housing in the vibration node in transverse direction to the longitudinal direction at the surface of the housing for storing in the slot of the bearing bracket. Depending on the form of the vibration node the extension in transverse direction can be rather dot-shaped or ring-shaped, whereby the extension can be accommodated by the position element at random positions along the perimeter in the presence of a node level. An alternative is the accommodation as a slot, in particular construed as a circumferential slot, whose axial extent is ideally concentrated on the node level as much as possible. By clamping the extension in transverse direction between two fixing plates that are construed as slots manufacturing tolerances can be easily balanced and by clamping the two plates a very high rigidness of the strong elements can be achieved, which is higher than the rigidness of the piezo actuators. The fixing plates can thereby be arranged almost parallel to the bridging web, whereby the bridging web is arranged almost parallel to the fixing plates, between which the slots are clamped. In this embodiment the friction element can be shifted on the bridging web in a pushing or elliptical movement optionally by one of the two piezo actuators or by a common excitation of the two piezo actuators. The bearing bracket for a window regulator drive in a motor vehicle can for example be fixed at a window pane. Due to a direct creation of a linear movement a very fast with a high dynamic is enabled. Due to the micro stroke principle a very precise positioning of the part that has to be adjusted can be achieved at low noise emissions.

Embodiments of the invention are illustrated in the drawings and further explained in the following description. It is shown in:

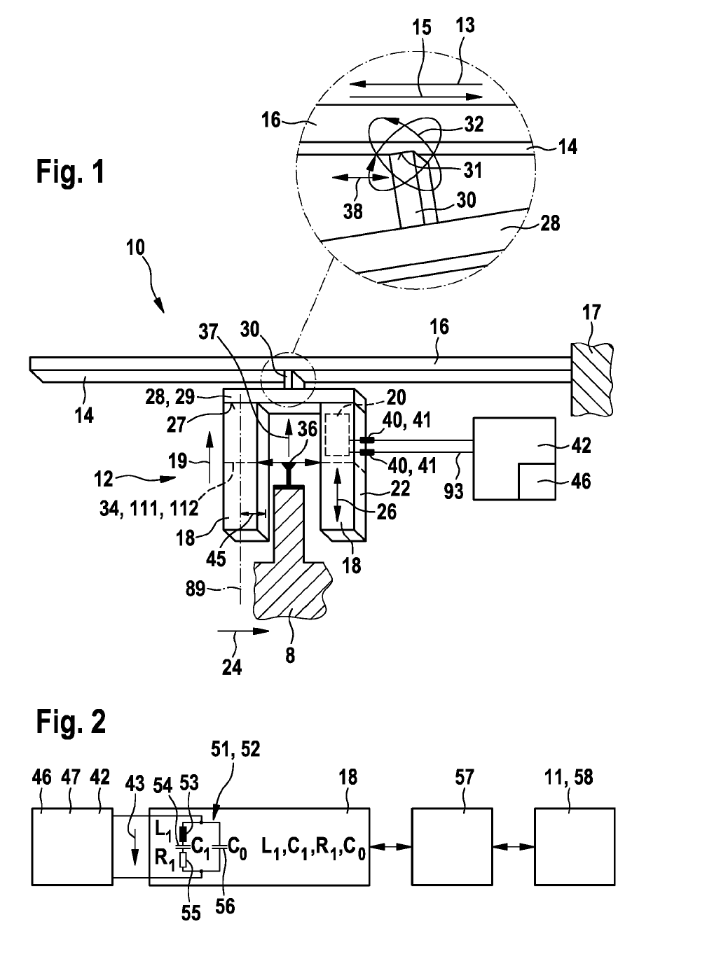

FIG. 1 a piezoelectric drive device according to the invention,

FIG. 2 a schematic illustration for operating the drive device,

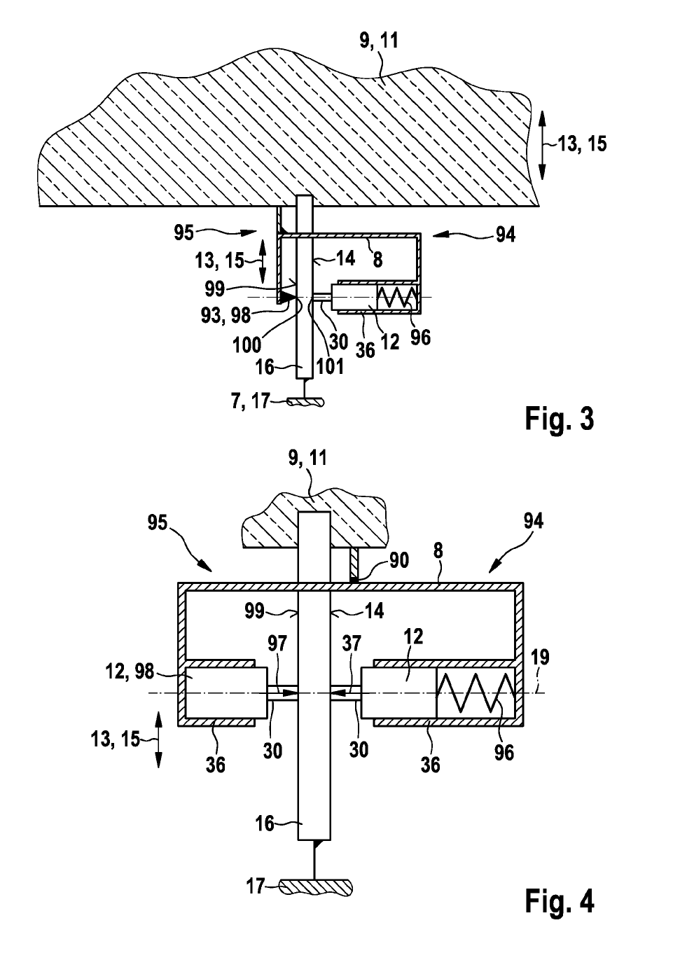

FIGS. 3 to 7 different embodiments of the piezo motor storage, and

FIG. 8 several variant of guide rails.

FIG. 1 shows a piezoelectric drive device 10, at which the piezo motor 12 carries out a relative movement towards a corresponding friction surface 14. The friction surface 14 is thereby construed as a linear rail 16, which is for example attached at a car body part 17. The piezo motor 12 provides at least one piezo actuator 18, which contains a piezo element 20. The piezo actuator 18 provides therefore an actuator housing 22, which accommodates the piezo element 20. The actuator housing 22 is for example construed as a capsule. The piezo element 20 is enclosed by the actuator housing 22 in the shown embodiments. The piezo actuator 18 provides a longitudinal direction 19, in whose direction the extension of the piezo actuator 18 is longer than in transverse direction 24. The piezo element 20 is preferably pre-stressed in longitudinal direction 19 in the actuator housing 22 in such a way that no pulling forces occur in the piezo element 20 during an excitation of a longitudinal vibration 26 of the piezo element 20. Due to the vibration of the piezo element 20 the entire piezo actuator 18 is put into longitudinal vibration 26 and transfers a vibration amplitude 45 over a bridging web 28 onto a friction element 30, which is in frictional contact with the friction surface 14. Due to the longitudinal vibration 26 of the piezo actuator 18 the bridging web 28 is put into a tipping movement or a bending movement, so that an end 31 of the friction element 30 that is pointed towards the friction surface 14 carries out a micro pushing movement. The interactions between the friction element 30 and the friction surface 14 is illustrated in the enlarged section, in which it can be seen that the bridging web 28, which is arranged in a resting position almost parallel to the friction surface 14, tips towards the friction surface 14 at an excited vibration of the piezo actuator 18. Thereby the end 31 of the friction element 30 carries out an elliptical movement 32 or a circular movement, due to which the piezo motor 12 pushes off along the linear rail 16. The piezo motor 12 stored in the area of a vibration node 34 of the piezo actuators 18 and for example connected with the aid of a bearing bracket 8 (only shown partially) to an adjusting part 11. The vibration node 34 is construed as node level 111 at the longitudinal vibration 26 of the piezo actuator 18, which spans approximately vertically to the longitudinal direction 19. The piezo actuator 18 is absorbed by a slot 36 of the bearing bracket 8 at an outside peripheral line 112, which is created by the cut of the node level 18 through the piezo actuator 18. The vibration node 34 is therefore determined with the aid of a simulation and/or empirically. Simultaneously the piezo motor 12 is pressed against the friction surface 14 over a bearing bracket 8 with a normal force 37. Thereby the end 31 of the friction element 20 carries out an elliptical movement 32, which provides in addition to the normal force 37 a tangential force component 38, which causes the advance of the piezo motor 12 towards the friction surface 14. In an alternative embodiment the friction element 30 only carries out a pushing movement under a certain angle to the normal force 37. This also results in a relative movement by means of micro strokes.

In the embodiment according to FIG. 1 the piezo motor 12 provides exactly two piezo actuators 18, which are both arranged almost parallel to its longitudinal direction 19. The bridging web 28 is thereby arranged transversally to the longitudinal direction 19 and connects the two piezo actuators 18 at their front sides 27. The bridging web can thereby be also made off one piece with the actuator housing 22. The bridging web 28 is for example construed as flat plate 29, in whose middle the friction element 30 is arranged. In a preferred operating mode of the piezoelectric derive device 10 only one of the two piezo actuators 18 is exited for a relative movement in a first direction 13. The second not exited piezo actuator 18 works thereby as vibration mass over the bridging web 28, due to which the bridging web 28 is tipped or bended towards the longitudinal direction 19 with the friction element 30. According to the rigidness of the construction of the piezo motor 12 the longitudinal vibration 26 of the piezo element 20 is converted into a micro pushing movement with a tangential force component 38. The electric excitation of the piezo element 20 takes place over electrodes 40, which are connected with an electronic unit 42 by a contacting element 41. For a movement of the piezo motor 12 into the opposite directions 15 the piezo element 20 of the other piezo actuator 18 is exited correspondingly with the aid of the electronic unit 42. Only one piezo element 20 of the piezo motor 12 is always excited at this operating mode, so that there can be no overlapping of two vibration excitations of both piezo actuators 18.

The piezoelectric drive device 10 is for example operated in its resonance frequency. The electronic unit 42 provides therefore a set-up switch 46, which controls the corresponding piezo element 20 in such a way that the entire system vibrates in resonance. The electronic unit 42 can for example be at least partially arranged within the actuator housing 22 or the bearing 36. The amplitudes 45 of the resonance frequency of the longitudinal vibration 26 are illustrated in FIG. 1 in the two piezo actuators 18. The maximum amplitudes 45 correspond here with the mechanic resonance frequency.

FIG. 2 illustrates a model of the piezoelectric drive device 10, which serves as basis for adjusting the resonance frequency. The piezo actuator 18 is thereby illustrated as resonant circuit 52, in which an inductivity 53 is switched in series with a capacity 54 and an ohmic load 55. Parallel a second capacity 56 is therefore applied. An excitation voltage 43 is applied at the resonant circuit 52 with the aid of the electronic unit 42. Furthermore the resonance frequency of the entire drive device 10 depends on the load 58, which is for example determined by the weight of the part 11 that has to be adjusted and/or the friction condition between the friction element 30 and the friction surface 14, which is schematically illustrated by the mechanic force transmission 57.

FIG. 3 shows a further embodiment of a piezoelectric drive device 10 according to the invention, at which a piezo motor 12 is used for example according FIG. 1 or another random piezo motor 12. The guide rail 16 is arranged stationary, for example attached as car body part 17 at a side door 7. A window pane 9 is adjusted along the guide rail 16 as movable part 11. The bearing bracket 8 is firmly connected with the movable part 11, for example by a single fixing point 90, which is arranged approximately in the center of the window pane 9. The bearing bracket 8 provides a slot 36 on a first side 94, in which the piezo motor 12 is preferably fixed at the vibration node 34 of the piezo actuator 18 (see for example FIG. 1). The piezo motor 12 is pressed against the guide rail 16 by the bearing bracket 8 with the aid of a spring element 96, so that the friction element 30 is in a sufficient friction contact with the friction surface 14. In order to provide a counter force 97 (towards the normal force 37) a counter element 98 is arranged as pressure element 93 at the bearing bracket 8 on the second side 95, which is in contact with the backside 99 of the guide rail 16. The contact point 100 of the counter element 99 is thereby arranged opposite of the contact point 101 of the friction element 30, so that both are located almost in one line along the longitudinal direction 19 of the piezo actuator 18. The contact point 101 and the contact point 100 are thereby arranged approximately dot-shaped, but can also provide a linear or planar expansion. The pressure element 93 is for example construed as plain bearing, rolling bearing or other guiding areas with more or less expanded contact points 100. The bearing bracket 8 is connected with the movable part 11 at the second side 95 in this embodiment, but the fixing point 90 can alternatively also be arranged symmetrically in the center of the bearing bracket 8 (FIG. 4).

In a variation of this embodiment the counter element 98 on the second side 95 of the bearing bracket is also construed as piezo motor 12 in FIG. 4. It is also stored in a slot 36 and applies a counter force 97 on the friction element 30 of the first piezo motor 12 instead of the pressure element 93. Both friction elements 30 of the piezo motors 12 expand thereby approximately along a line, preferably the longitudinal direction 19 of the piezo actuators 18. The second piezo motor 12 that works as counter element 98 is not stored flexibly in the slot 36 in this embodiment, so that the opposite pressure force of the two friction elements 30 is only set by the one spring element 96. In that case the bearing bracket 8 is attached approximately in the center of the part 11 that has to be adjusted.

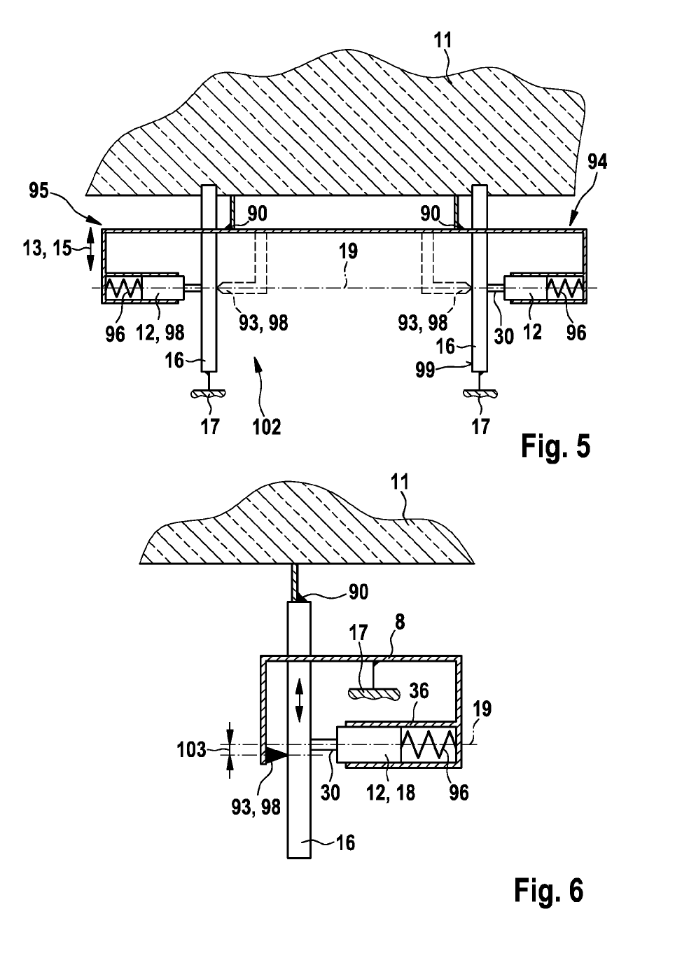

In a further embodiment of the drive device 10 according to the invention, which is shown in FIG. 5, two guide rails 16 are arranged stationary, which expand approximately parallel. Such an embodiment is preferred, if the part 11 that has to be adjusted exceeds a certain size. The bearing bracket 8 is attached at the movable part 11, for example symmetrically with the aid of two fixing points 90. The bearing bracket 8 expands in this embodiment over the entire spacing 102 between the two guide rails 16 and encompasses the latter in such a way that a counter force 97 works against the pressure force 37 that is applied to the front side of the first guide rail 16, which engages at the backside 99 of the second guide rail 16 that is turned away from the first guide rail 16. The counter element 98 is here construed as piezo motor 12, so that the two friction elements 30 are arranged approximately in a line along the longitudinal direction 19 and are in contact with the two friction surfaces of two different guide rails 16 that are pointing away from each other. Both piezo motors 12 are thereby stored in their slots 36 each with spring elements 96, whereby a better tolerance balance takes place.

In a variation of this embodiment additionally one or two further pressure elements 93 can be arranged (indicated by a dotted line), which face the corresponding friction elements 30 at the corresponding guide rails 16. The pressure force of the two friction elements 30 is thereby additionally stabilized.

A further embodiment is illustrated in FIG. 6, which distinguishes itself from the embodiment in FIG. 3 thereby that the guide rail 16 is here fixedly connected with the part 11 that has to be adjusted, and that it moves together with it relative to the stationary piezo motor. The bearing bracket 8 is therefore for example fixedly connected with the car body part 17. The bearing bracket 8 provides therefore a fixing point 90 in the middle area of the bearing bracket, at which the bearing bracket 8 is fixed on the side door. Because the guide rail 16 moves along in this embodiment, there has to be enough installation space for sinking the guide rail 16. The contact point 100 of the counter element 98 provides a drift 103 to the contact point 101 of the friction element of the first piezo motor 12 in this embodiment. This drift 103 along the moving direction 13, 15 causes an additional tangential force component at the force transmission through the friction element 30 on to the friction surface 14. Such a drift 103 can also be realized when suing a second piezo motor 12 as counter element 98.

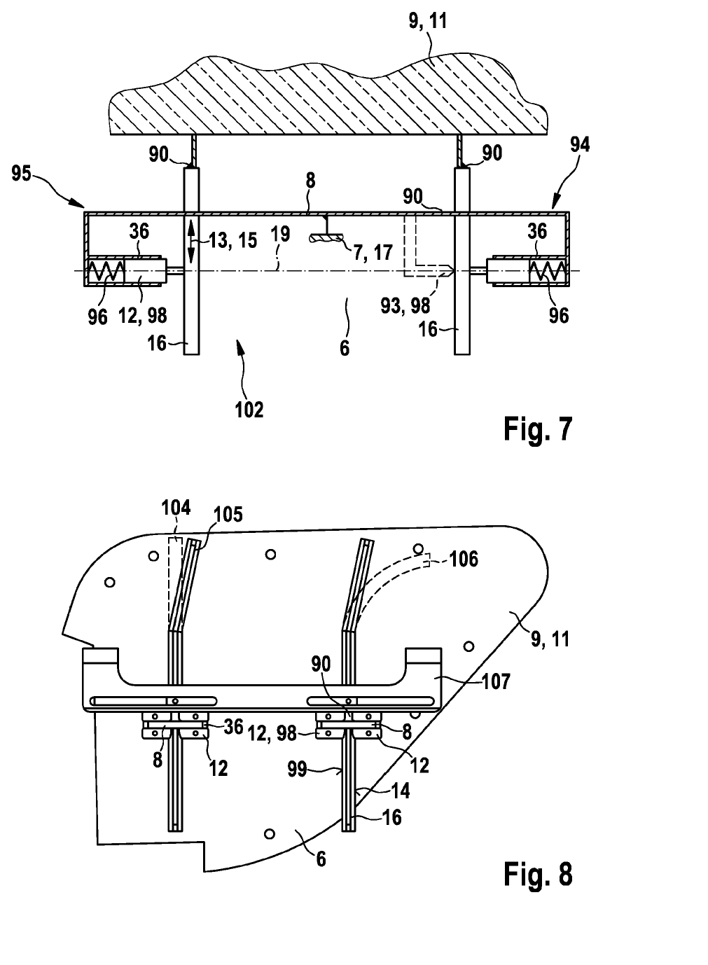

FIG. 7 shows an embodiment that is analogous to the drive device in FIG. 5, at which two guide rails 16 are attached at a (common) movable part 11. The two guide rails 16 can be adjusted towards the fixed bearing bracket 8 together with the movable part 11. A second piezo motor 12 is again provided as counter element 98, so that according to the embodiment in FIG. 5 again two friction elements 30 are in contact with the two outside friction surfaces 14 of two different guide rails 16. The bearing bracket 8 is attached approximately in the middle of the car body part 17, so that the entire bearing bracket 8 is construed symmetrically at the fixing point 90. In a further variation additional pressure elements 93 can be again arranged like in FIG. 5, in order to enable a constant pressure force 37.

In a not further shown embodiment according to FIG. 8 the two guide rails 16 are not construed as continuous straight lines 104 but they provide snapped off straight sections 105, which again run approximately parallel. On the left side the two parallel straight lines 104 are indicated as guide rails 16 by dotted lines as it is described for example in FIG. 5. As a further variation an arch-shaped guide rail 16 is shown by a dotted line on the right side, towards which preferably also a second arch-shaped guide rail 16 runs approximately parallel. The guide rails 104, 105, 106 are for example construed stationary, so that the movable part 11 can be shifted with the piezo motors 12 that are arranged at it along the guide rails 104, 105, 106. A first piezo motor 12 is connected on the right side with a counter element 98 that is construed as second piezo motor 12 by a first bearing bracket 8. The bearing bracket 8 is connected with the movable part 11 by means of a fixing point 90 with the aid of a further fixing device 107. A second bearing bracket 8 is arranged on the left side, which also accommodates two opposite piezo motors 12.

It shall be noted that with regard to the embodiments that are shown in the figures and in the description diverse combinations of the individual characteristics are possible. Thus for example the concrete construction of the piezo motors 18, their actuator housings 22, their piezo elements 20 and the friction elements 30 can be varied according to the application. The pushing movement can be thereby construed as pure pushing movement or basically as elliptical or circular movement path, whereby the friction pairing between the friction element 30 and the friction surface 14 provides a higher or lower friction coefficient according to the transverse component of the force transmission. The pure linear pushing movement illustrates thereby the marginal case of the elliptical movement. A pure form fit is also possible as marginal case, at which the friction element 30 reaches into a corresponding recess without a friction, for example into a micro gearing of the drive element, for example the guide rail 16. All piezo motors 18 can be accommodated in a single bearing bracket 8 or be individually fixed in several bearing brackets 8. The concrete configuration of the slot 36 furthermore depends on the form of the actuator housing 22 and the exited vibration form. The drive device 10 according to the invention for adjusting the movable part 11 (seat parts, window panes, roof, hatches) is preferably used in motor vehicles, but is not limited to such an application.

1. Piezoelectric drive device for adjusting movable parts, particularly in a motor vehicle, with a piezo motor that provides at least one piezo actuator with an electric piezo element, wherein at least one friction element is arranged at the piezo motor, which interacts with a friction surface of at least one guide rail opposite said friction element for creating a relative movement, wherein the friction surface is positioned opposite of the friction element wherein the at least one piezo motor is supported on a first side of a bearing bracket and a counter element is arranged on a second opposite side of the bearing bracket, which exerts a counter force to the friction element onto the at least one guide rail.

2. Piezoelectric drive device according to claim 1 wherein the counter element is construed as a further piezo motor with a friction element.

3. Piezoelectric drive device according to claim 1, wherein the counter element is construed as a pressure element that is fixedly connected to the bearing bracket.

4. Piezoelectric drive device according to claim 1, wherein the at least one guide rail bended or straight or construed as snapped-off straight sections.

5. Piezoelectric drive device according to claim 1, wherein a contact point of the friction element of the at least one piezo motor and a counter contact point of the counter element are arranged approximately in a single plane transversely to the relative movement or with a drift as to the movement direction of the part.

6. Piezoelectric drive device according to claim 1, wherein the counter element contacts at the same guide rail as the friction element of the at least one piezo motor, in particular at the backside of the guide rail that is on opposite side of the friction surface.

7. Piezoelectric drive device according to claim 1, wherein the counter element contacts at a second guide rail, which is arranged approximately parallel to the guide rail, at which the friction element of the at least one piezo motor contacts, in particular at a backside of the second guide rail that is on the opposite side of the friction surface.

8. Piezoelectric drive device according to claim 1, wherein the at least one piezo motor and/or the counter element are each arranged in a slot of the bearing bracket with the aid of a spring, which exerts a preload force, with which the at least one piezo motor and/or the counter element are pressed against the at least one guide rail basically transversely to the moving direction of the part.

9. Piezoelectric drive device according to claim 1, wherein the bearing bracket is arranged fixedly, in particular attached fixedly at a car body part for example a vehicle door, and the guide rail is arranged movably.

10. Piezoelectric drive device according to claim 1, wherein the bearing bracket is attached at the movable part and that the guide rail is arranged fixedly, in particular attached fixedly at a car body part.

11. Piezoelectric drive device according to one of the claim 1, wherein the bearing bracket is attached at a single or two fixing points at the movable part or at the car body part.

12. Piezoelectric drive device according to claim 1, wherein during the creation of a single fixing point said point is arranged in the center with regard to the plane transversely to the relative movement—in particular to the fixture at the car body part.

13. Piezoelectric drive device according to claim 1, wherein exactly one, two, three or four piezo motors are arranged at a single bearing bracket, which each interact with friction surfaces, which are arranged at the front side and/or backside of exactly one or exactly two guide rails.

14. Piezoelectric drive device according to claim 1, wherein the at least one piezo actuator of the at least one piezo motor is directly or indirectly fixed to the bearing bracket in the area of a nodal point of vibration (amplitude zero point) of the excited piezo actuator vibration.

15. Piezoelectric drive device according to claim 1, wherein the at least one guide rail is an integral part of the movable part—in particular a window pane.

16. Piezoelectric drive device according to claim 1, wherein at least one piezo motor and the at least one guide rail are arranged outside of the middle area of the window pane in the vehicle door in such a way that a free installation space—for example for building in airbags or speakers—are provided in the middle area of the vehicle door.
